(19) United States
(12) Patent Application Publication
(10) Pub. No.: US 2008/0252576 A1
(43) Pub. Date: Oct. 16, 2008

(54) PANEL DISPLAY APPARATUS AND SOURCE DRIVER THEREOF

(75) Inventor: Chih-Chiang Chuang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/767,532

(22) Filed: Jun. 25, 2007

(30) Foreign Application Priority Data
Apr. 16, 2007 (TW) 96113305

(51) Int. Cl. G09G 3/36

(52) U.S. Cl. 345/87

(57) ABSTRACT

A panel display apparatus and a source driver including a set of first input terminals, a set of second input terminals, a set of first output terminals, a set of second output terminals, an interface module and a driving module are disclosed. The sets of the first and the second input terminals are coupled to a previous source driver and a timing controller, respectively. The sets of the first and the second output terminals are coupled to a following source driver and a display panel, respectively. The interface module selects the set of the first or the second input terminals upon a pre-setting, and connects the selected input terminals to the set of the first output terminals. The driving module generates at least a driving signal upon a signal of the selected input terminals. The driving signal is outputted to the display panel through the second output terminals.

### CROSS-REFERENCE TO RELATED APPLICATION

This application claims the priority benefit of Taiwan application serial no. 96113305, filed Apr. 16, 2007. All disclosure of the Taiwan application is incorporated herein by reference.

### BACKGROUND OF THE INVENTION

1. Field of the Invention

The present invention generally relates to a display, and more particularly to a panel display apparatus and a source driver thereof.

2. Description of Related Art

In a conventional chip on glass (COG) technique, a transistor-transistor logic type (TTL-type) data bus or a differential-type data bus has a complicated connection between a timing controller integrated circuit and a driver integrated circuit. FIG. 1 depicts the connection between a timing controller 110 and drivers 130-1, 130-2 . . . , 130-n in a conventional panel display apparatus. Through connectors 120-1, 120-2, . . . , and 120-n, the source drivers 130-1, 130-2 . . . , and 130-n are electrically connected in parallel to the timing controller 110.

As shown in FIG. 1, each of the source drivers requires one connector welded to a liquid crystal display panel 100. Since the connectors 120-1˜120-n connect each of the source drivers 130-1˜130-n, the timing controller 110 may transmit a control signal and image data to each of the source drivers 130-1˜130-n. Driving modules in the source drivers 130-1˜130-n then drive a pixel array 101 on the liquid crystal display panel 100 based on the control signal and the image data outputted by the timing controller 110. Accordingly, each of the source drivers requires a corresponding connector to connect the timing controller 110.

During the conventional process of fabricating the COD liquid crystal display panel 100, each connector is more unapt to connect a pad on a glass substrate due to an increase in size of the display panel and a requirement for more source drivers and connectors. That is to say, with the increase in the number of the connectors, the percentage of failure in the connection may be correspondingly raised.

FIG. 2 depicts the connection between a timing controller 210 and source drivers 230-1, 230-2 . . . , and 230-n in another conventional panel display apparatus. With use of a single connector 220, a control signal and image data outputted by the timing controller 210 are transmitted to a bus 202 on a conventional liquid crystal display panel 200. The source drivers 230-1˜230-n are electrically connected in parallel to the bus 202, respectively. Thus, driving modules in the source drivers 230-1˜230-n can receive the control signal and the image data outputted by the timing controller 210 and then drive a pixel array 201 on the liquid crystal display panel 200. Since the source drivers 230-1˜230-n can receive the control signal and the image data outputted by the connector 220, the electrical connections for a signal flow among the source drivers 230-1˜230-n are in parallel. However, the resistance of the bus 202 on the liquid crystal display panel 200 is hardly negligible, leading to a signal decay at a terminal of the bus 202 and a high signal distortion.

To reduce the number of the connectors, lower the percentage of failure in the connections between the connectors and the glass substrate, and resolve issues regarding the signal decay and the signal distortion, the solutions in this regard have been successively proposed in conventional techniques (e.g. in U.S. publications Nos. 2005/0184978 A1, 2006/0202936 A1, 2006/0012550 A1, and so on). FIG. 3 depicts the connection between a timing controller 310 and source drivers 330-1, 330-2 . . . , and 330-n in still another conventional panel display apparatus. The source drivers 330-1˜330-n disposed on a liquid crystal display panel 300 are electrically connected to one another in series. With a signal connector 320, the timing controller 310 may merely be connected to the first source driver 330-1 in the conventional technique. Thus, driving modules in the source driver 330-1 can receive a control signal and image data outputted by the timing controller 310 through the connector 320 and drive a pixel array 301 on the liquid crystal display panel 300. On the other hand, the source driver 330-1 processes (e.g. amplifies) the control signal and the image data outputted by the connector 320, and the processed control signal and the processed image data are outputted to a following-stage source driver 330-2. The principles of operating the other source drivers 330-2˜330-n are similar to that of operating the source driver 330-1, and thus no further description is provided herein. Since the following-stage source driver (e.g. 330-2) receives the control signal and the image data processed by a previous-stage source driver (e.g. 330-1), the electrical connections for the signal flow among the source drivers 330-1˜330-n are in serial.

The number of the connectors is reduced by adopting said methods. Nevertheless, circuits connected to the source drivers 330-1˜330-n are mostly disposed on the glass substrate of the liquid crystal display panel 300. Due to material properties, the resistance of the circuits on the glass substrate is more significant. Therefore, no matter the signal on the glass substrate is the differential-type signal or the TTL-type signal, the amplitude of said signal may decay to a great extent, such that the time management of operating the source drivers is not apt to be implemented, which results in defects or abnormalities in images displayed by the liquid crystal display panel 300.

### SUMMARY OF THE INVENTION

The present invention is directed to a source driver for users to receive data either in a series mode or in a parallel mode, so as to improve a signal decay or a signal distortion in a proper manner. Besides, the percentage of failure in connections can also be raised by reducing the number of connectors.

The present invention is directed to a panel display apparatus for users to configure each source driver to operate either in a series mode or in a parallel mode in a flexible manner, so as to properly improve a signal decay or a signal distortion. Besides, the percentage of failure in connections can also be raised by reducing the number of connectors.

To resolve said issues, the present invention provides a source driver including a set of first input terminals, a set of second input terminals, a set of first output terminals, a set of second output terminals, an interface module and a driving module. The set of the first input terminals may be coupled to a previous-stage source driver. The set of the second input terminals may be coupled to a timing controller. The set of the first output terminals may be coupled to a following-stage source driver. The set of the second output terminals may be coupled to a display panel. The interface module is coupled to the sets of the first and the second input terminals for selecting the set of the first input terminals or the set of the second input terminals based on a pre-setting and electrically connecting the selected set of the input terminals with the set of the first output terminals. The driving module is coupled to the interface module. Besides, the driving module generates at least a driving signal based on a signal of the selected set of the input terminals. The driving signal is outputted to the display panel through the set of the second output terminals.

The present invention further provides a panel display apparatus including a display panel, at least a connector, a timing controller and a plurality of source drivers. A surface of the display panel has a layout including a plurality of source driver pads and a plurality of connector pads. Each of the source driver pads is electrically connected to one of the connector pads, and the source driver pads are connected to one another in series. A first end of the connector is disposed in one of the connector pads. The timing controller is electrically connected to a second end of the connector, so as to couple the display panel through the connector. Each of the source drivers disposed in one of the source driver pads includes a set of first input terminals, a set of second input terminals, a set of first output terminals, a set of second output terminals, an interface module, and a driving module. The set of the first input terminals is coupled to a previous-stage source driver through the source driver pads located at a position where the set of the first input terminals is located. The set of the second input terminals is coupled to the connector pads through the source driver pads located at a position where the set of the second input terminals is located. The set of the first output terminals is coupled to a following-stage source driver through the source driver pads located at a position where the set of the first output terminals is located. The set of the second output terminals is coupled to a pixel array of the display panel through the source driver pads located at a position where the set of the second output terminals is located. The interface module is coupled to the sets of the first and the second input terminals. Additionally, the interface module selects the set of the first input terminals or the set of the second input terminals based on a pre-setting, and electrically connects the selected set of the input terminals with the set of the first output terminals. The driving module is coupled to the interface module. Besides, the driving module generates at least a driving signal based on a signal of the selected set of the input terminals, and the driving signal is outputted to the pixel array of the display panel through the set of the second output terminals.

Due to the disposition of the interface module in the source driver proposed in the present invention, the interface module selects the set of the first input terminals or the set of the second input terminals based on the pre-setting. Thus, the user is able to configure each source driver to operate either in the series mode or in the parallel mode in a flexible manner. Thereby, the signal decay or the signal distortion can be properly improved, and the percentage of failure in connections can be raised by reducing the number of connectors.

In order to make the aforementioned and other objects, features and advantages of the present invention more comprehensible, several embodiments accompanied with figures are described in detail below.

### BRIEF DESCRIPTION OF THE DRAWINGS

FIG. 1 depicts the connection between a timing controller and drivers in a conventional panel display apparatus.

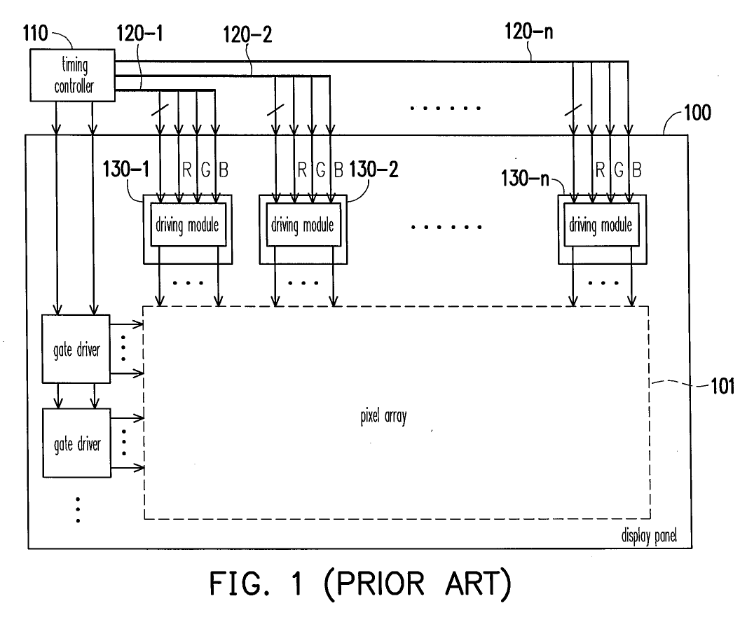

FIG. 2 depicts the connection between the timing controller and source drivers in another conventional panel display apparatus.

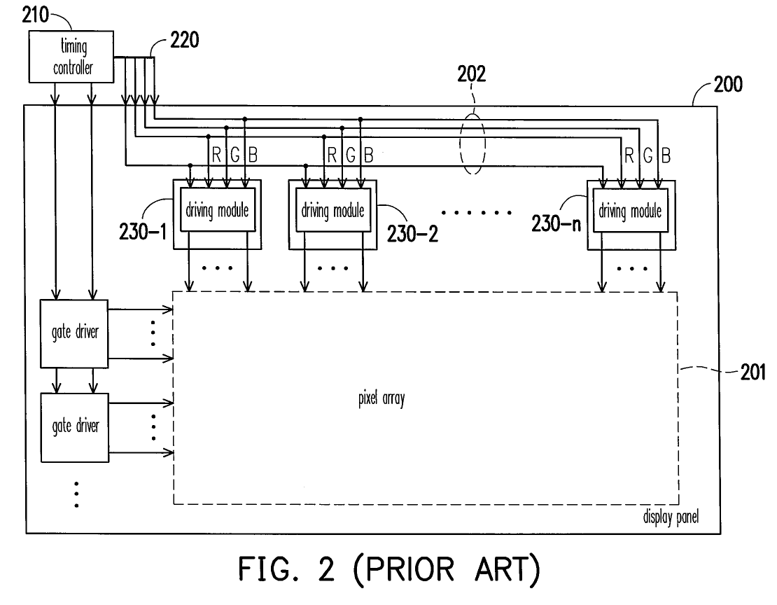

FIG. 3 depicts the connection between the timing controller and the source drivers in still another conventional panel display apparatus.

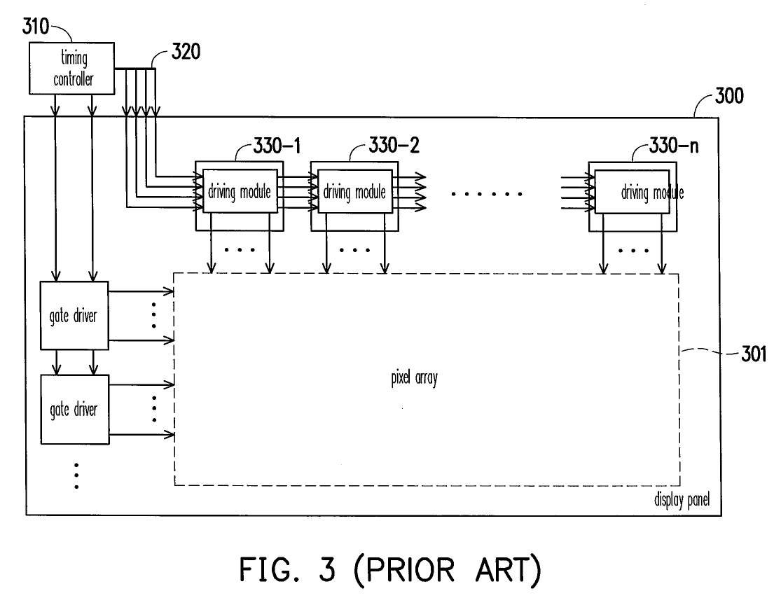

FIG. 4 depicts a panel display apparatus according to an embodiment of the present invention.

FIG. 5 depicts an interface module provided in FIG. 4 according to an embodiment of the present invention.

FIG. 6 depicts a driving module provided in FIG. 4 according to an embodiment of the present invention.

### DESCRIPTION OF EMBODIMENTS

In a variety of COG techniques, as provided hereinbefore, a signal decay may not be avoided no matter source drivers operate either in a series mode or in a parallel mode. Moreover, an excessive number of connectors adopted in said techniques may lead to an increase in the percentage of failure in connections between the connectors and a glass substrate. According to an aspect of the present invention, several embodiments are proposed to resolve said issues.

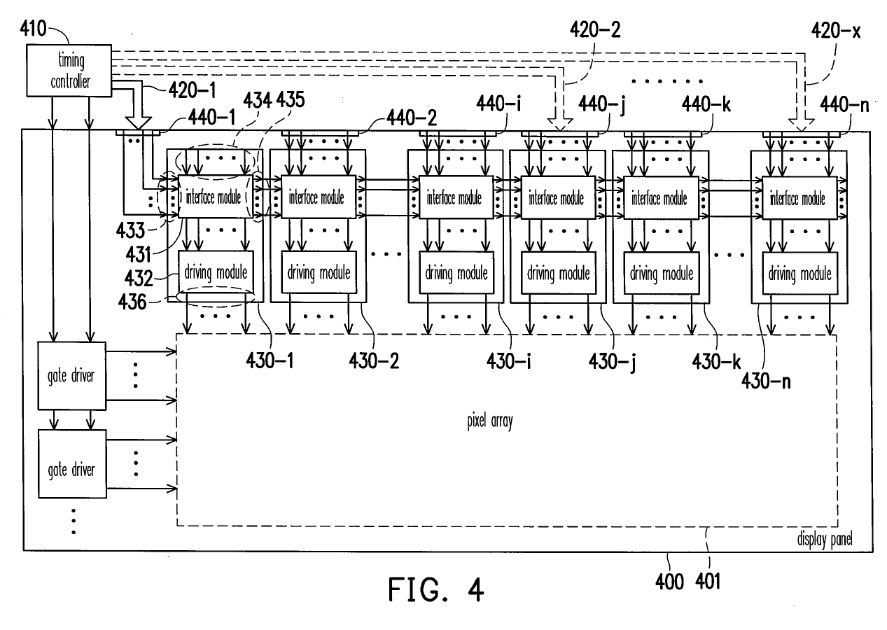

According to the present invention, exemplary solutions are provided hereinafter, such that people who apply the present invention may configure each source driver to operate either in the series mode or in the parallel mode in a flexible manner based on a certain degree to which the amplitude of the signal decays during the stages of designing or of fabricating the products. In the present embodiment, a serial connection and a parallel connection are both applied, such that a user is allowed to configure each source driver to operate either in the series mode or in the parallel mode in a flexible manner. FIG. 4 depicts a panel display apparatus according to an embodiment of the present invention. In the present embodiment, a substrate in a display panel 400 is presumably made of glass, but the present invention is not intended to pose limitations on the material of the substrate.

Referring to FIG. 4, the panel display apparatus includes the display panel 400, connectors 420-1 and 420-2, a timing controller 410, and source drivers 430-1, 430-2, . . . , 430-i, 430-j, 430-k, . . . , and 430-n. A surface of the display panel 400 has a layout including a plurality of source driver pads and a plurality of connector pads. The source driver pads are used to load the source drivers. FIG. 4 does not illustrate each of the source driver pads welded to the source drivers 430-1˜430-n. On the other hand, the connectors may be connected to the glass substrate of the display panel 400 through the connector pads. Here, the source driver pads are electrically connected to one of the connector pads 440-1, 440-2, . . . , 440-i, 440-j, 440-k, . . . , and 440-n. For example, the source driver pad welded to the source driver 430-2 is connected to the connector pad 440-2 through an electrical path on the glass substrate. Further, the source driver pads are connected to one another through the electrical path on the glass substrate, such that the source drivers 430-1˜430-n may form a series structure together with the source driver pads, as indicated in FIG. 4. In the present embodiment, the source drivers and the previous-stage/following-stage source drivers thereof can be connected by (indium tin oxide) ITO, and so can the source driver pads and the connector pads.

First ends of the connectors 420-1 and 420-2 are disposed in one of the connector pads, respectively. For example, the connector 420-1 is connected to the connector pad 440-1, while the connector 420-2 is connected to the connector pad 440-j. On the other hand, second ends of the connectors 420-1 and 420-2 are electrically connected to the timing controller 410. As such, the timing controller 410 may be coupled to the display panel 400 through the connectors 420-1 and 420-2.

The source drivers 430-1˜430-n are disposed on the substrate of the display panel and are connected to one of the source driver pads, respectively. Here, the source drivers 430-1˜430-n are electrically connected to the corresponding source driver pads by implementing the COG packaging technique. In the present embodiment, the source drivers 430-1˜430-n may adopt the same design. Thus, only an embodiment of the source driver 430-1 is provided hereinafter. The other source drivers 430-2˜430-n may be embodied with reference to the source driver 430-1.

The source driver 430-1 includes a set of first input terminals 433, a set of second input terminals 434, a set of first output terminals 435, a set of second output terminals 436, an interface module 431 and a driving module 432. Since the source driver 430-1 is welded to the source driver pad located at a position where the source driver 430-1 is located, the set of the first input terminals 433 may be coupled to the previous-stage source driver. However, since the source driver 430-1 does not have the previous-stage source driver, the set of the first input terminals 433 is connected to the connector pad 440-1 in the present embodiment.

The source driver 430-1 is welded onto the source driver pad-located at the position where the source driver 430-1 is located. Thus, the set of the second input terminals 434 may be coupled to the corresponding connector pads, the set of the first output terminals 435 may be coupled to the following-stage source driver 430-2, and the set of the second output terminals 436 may be coupled to a pixel array 401 of the display panel 400. In the present embodiment, the connector pad 440-1 of the source driver 430-1 is connected to the set of the first input terminals 433, and accordingly the set of the second input terminals 434 of the source driver 430-1 may be floated. However, in other embodiments, the connector pad 440-1 may be connected to the set of the second input terminals 434 of the source driver 430-1, and the set of the first input terminals is floated.

The interface module 431 is coupled to the set of the first input terminals 433 and the set of the second input terminals 434. Based on a pre-setting, the interface module 431 selects the set of the first input terminals 433 or the set of the second input terminals 434 and electrically connects the selected set of the input terminals (433 or 434) to the set of the first output terminals 435. The driving module 432 is coupled to the interface module 431. Besides, the driving module 432 generates at least a driving signal based on an output of the interface module 431 (i.e. a signal of the selected set of the input terminals). The driving signal is outputted to the pixel array 401 of the display panel 400 through the set of the second output terminals 436.

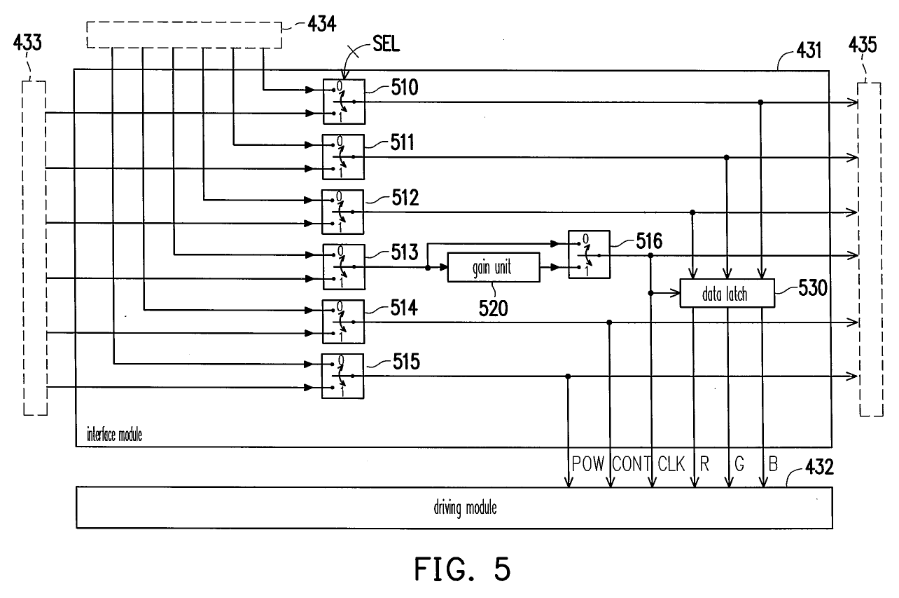

FIG. 5 depicts the interface module 431 provided in FIG. 4 according to an embodiment of the present invention. The interface module 431 includes switches 510, 511, 512, 513, 514 and 515, a gain unit 520 and a data latch 530. The switches 510˜515 are monitored by a preset signal SEL. In addition, the source driver in the present embodiment further includes a select control terminal. The select control terminal is coupled to the interface module 431 as an input interface of the preset signal SEL.

Referring to FIG. 5, the switches 510˜512 are coupled to the set of the first input terminals 433 and the set of the second input terminals 434. Based on the preset signal SEL, the switches 510˜512 are allowed to select image data (e.g. red image data R, green image data G, or blue image data B) of the set of the first input terminals 433 or the set of the second input terminals 434 and transmit the selected image data to the set of the first output terminals 435. The switches 510˜512 are also coupled to the driving module 432, so as to transmit the selected image data of the set of the input terminals (433 or 434) to the driving module 432. Thereafter, the driving module 432 converts the image data outputted by the switches 510˜512 to a driving signal, so as to drive the pixel array 401 through the set of the second output terminals 436. Presumably, the interface module 431 determines to electrically connect the set of the first input terminals 433 to the set of the first output terminals 435 in case that the preset signal SEL is logic 1, and the interface module 431 determines to electrically connect the set of the second input terminals 434 to the set of the first output terminals 435 in case that the preset signal SEL is logic 0.

The switch 513 is coupled to the set of the first input terminals 433 and the set of the second input terminals 434. Based on the preset signal SEL, the switch 513 is allowed to select a clock signal supplied by the set of the first input terminals 433 or the set of the second input terminals 434 and transmit the selected clock signal to the gain unit 520 and the switch 516. The gain unit 520 is coupled to the switch 513 for gaining the clock signal selected by the switch 513. The switch 516 is coupled to the switch 513 and the gain unit 520. Based on the preset signal SEL, the switch 516 is allowed to select a clock signal CLK supplied by the switch 513 or the gain unit 520 and transmit the selected clock signal CLK to the set of the first output terminals 435 and the driving module 432. If the clock signal supplied by the switch 513 decays in a tolerable range, the user may control the switch 516 to select the clock signal supplied by the switch 513 based on the preset signal SEL to avoid that retardation of the clock signal CLK is increased. However, given that the amplitude of the clock signal supplied by the switch 513 decays to a great extent, the user may control the switch 516 to select the clock signal supplied by the gain unit 520 based on the preset signal SEL.

The data latch 530 is coupled to the switches 510˜512 and the switch 516. Through triggering the clock signal CLK outputted by the switch 516, the data latch 530 latches the image data R, G and B outputted by the switches 510˜512 and transmits the latched image data R, G and B to the driving module 432. The driving module 432 is coupled to the data latch 530, so as to convert the image data R, G and B outputted by the data latch 530 to the driving signal. Those who apply the present invention may take their demands into consideration and cancel the data latch 530, such that the image data R, G and B outputted by the switches 510˜512 are directly transmitted to the driving module 432.

The switch 514 is coupled to the set of the first input terminals 433 and the set of the second input terminals 434. Based on the preset signal SEL, the switch 514 is allowed to select a control signal CONT of the set of the first input terminals 433 or the set of the second input terminals 434 and transmit the selected control signal CONT to the set of the first output terminals 435 and the driving module 432. The control signal CONT may include a horizontal start pulse STH, a line latch signal LS, a polarity signal POL and/or other control signals. The driving module 432 is monitored by the control signal CONT outputted by the switch 514 and then generates the driving signal for driving the pixel array 401.

The switch 515 is coupled to the set of the first input terminals 433 and the set of the second input terminals 434. Based on the preset signal SEL, the switch 515 is allowed to select a power supply POW provided by the set of the first input terminals 433 or the set of the second input terminals 434 and transmit the selected power supply POW to the set of the first output terminals 435 and the driving module 432.

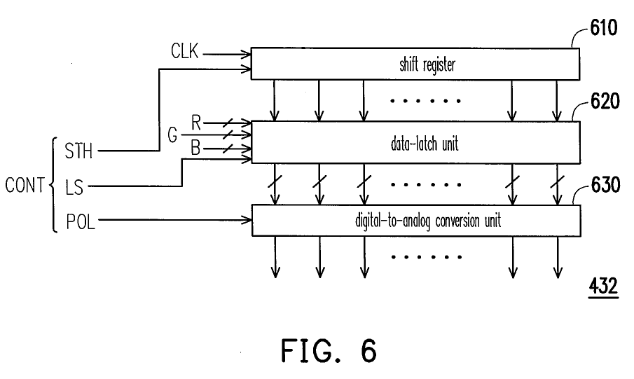

FIG. 6 depicts the driving module 432 provided in FIG. 4 according to an embodiment of the present invention. Here, it is presumed that the control signal CONT provided by the interface module 431 to the driving module 432 includes the horizontal start pulse STH, the line latch signal LS and the polarity signal POL. The driving module 432 includes a shift register 610, a data-latch unit 620 and a digital-to-analog conversion unit 630. The shift register 610 receives the horizontal start pulse STH and the clock signal CLK outputted by the interface module 431, so as to provide a latch timing to the data-latch unit 620. The data-latch unit 620 is coupled to the shift register 610 for latching the image data R, G and B outputted by the interface module 431 in corresponding channels based on the latch timing provided by the shift register 610. After that, the image data latched in respective channels are synchronically outputted to the digital-to-analog conversion unit 630 based on the line latch signal LS outputted by the interface module 431. The digital-to-analog conversion unit 630 is coupled to the data-latch unit 620 for converting the image data outputted by the data-latch unit 620 to the driving signal, so as to drive the pixel array 401 through the set of the second output terminals 436.

Referring to FIG. 4, the connectors 420-1 and 420-2 are employed in the previous embodiment, such that the signal and the data outputted by the timing controller 410 are transmitted to the connector pads 440-1 and 440-j. Accordingly, the preset signal SEL may be applied through the select control terminal of the source driver 430-j, and thereby the interface module of the source driver 430-j determines to receive the signal and the data of the connector pad 440-j. By contrast, the other source drivers 430-1˜430-i and 430-k˜430-n determine to receive the signals and the data provided by the previous-stage source drivers based on the select control terminals of the source drivers 430-1˜430-i and 430-k˜430-n. Here, the source drivers 430-1˜430-i are electrically connected to one another in series, and so are the source drivers 430-j˜430-n. The source drivers 430-1 and 430-j are, however, electrically connected in parallel to the timing controller 410. It should be noted that the interface module of the present embodiment merely performs signal conversion and signal output. Therefore, in terms of the signal flow, the source drivers 430-1˜430-i are electrically connected to one another in parallel, and so are the source drivers 430-j˜430-n.

Based on the above embodiments, the user is able to configure the source drivers to operate either in the series mode or in the parallel mode in a flexible manner based on the actual measurement of the signal decay during the fabrication of the products. For example, given that the signal of the source driver 430-n decays to a great extent according to an actual measuring result, the connector 420-x may be selectively added during the fabrication of the products, such that the signal and the data outputted by the timing controller 410 may be directly transmitted to the source driver 430-n through the connector pad 440-n. Thereby, the signal decay of the source driver 430-n and the following-stage source driver (not shown) thereof is improved.

On the contrary, if the signals of the source drivers 430-2˜430-n decay in a tolerable range based on the actual measuring result, the connector 420-2 may be selectively cancelled during the fabrication of the products. By applying the preset signal SEL via the select control terminal, the interface modules of the source drivers 430-1˜430-n determine to receive the signal and the data of the set of the first input terminals. The transmission path of the signals and the data outputted by the timing controller 410 through the connector 420-1 are partly within the source drivers 430-1˜430-n and partly on the glass substrate. Therefore, a reduction of the resistance on the transmission path is conducive to an improvement of the signal decay.

While being applied, the connectors 420-1˜420-x are usually fewer than the connector pads 440-1˜440-n. In other words, it is desired to have fewer number of the connectors 420-1˜420-x, so as to decrease the percentage of failure in the connections of the connectors.

Furthermore, the user is able to configure the source drivers to operate either in the series mode or in the parallel mode in a flexible manner based on the actual measurement of the signal decay during the stage of designing the products. Through a circuit simulation, the user may be aware of a certain degree to which the signal decays in each level of the transmission paths of the source drivers 430-1˜430-n. Accordingly, the user is able to decide the number of the connectors to be used in advance during the stage of designing the products. Besides, the user is capable of determining the level at which the connector is to be connected to the transmission paths of the source drivers 430-1˜430-n. After the decision is made, the user is then able to configure the state of each of the switches within the interface modules of the source drivers 430-1˜430-n. In this situation, the user may cancel the “select control terminal” of the interface modules of the source drivers 430-1˜430-n.

In view of the foregoing, due to the disposition of the interface module in the source driver proposed in the previous embodiments, the interface module is allowed to select the set of the first input terminals or the set of the second input terminals based on the pre-setting. Thus, the user is able to configure each source driver to operate either in the series mode or in the parallel mode in a flexible manner. Thereby, the signal decay or the signal distortion can be properly improved, and the percentage of failure in connections can be raised by reducing the number of connectors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver, comprising:
a set of first input terminals coupled to a previous-stage source driver;
a set of second input terminals coupled to a timing controller;
a set of first output terminals coupled to a following-stage source driver;
a set of second output terminals coupled to a display panel;
an interface module coupled to the sets of the first and the second input terminals, for selecting the set of the first input terminals or the set of the second input terminals based on a pre-setting and electrically connecting the selected set of the input terminals to the set of the first output terminals; and
a driving module coupled to the interface module, for generating at least a driving signal based on a signal of the selected set of the input terminals, wherein the driving signal is outputted to the display panel through the set of the second output terminals.

2. The source driver as claimed in claim 1, wherein the interface module comprises:
a first switch coupled to the sets of the first and the second input terminals, for selecting image data of the set of the first input terminals or image data of the set of the second input terminals and transmitting the selected image data to the set of the first output terminals,
wherein the driving module is coupled to the first switch, so as to convert the image data outputted by the first switch to the driving signal.

3. The source driver as claimed in claim 1, wherein the interface module comprises:
a first switch coupled to the sets of the first and the second input terminals, for selecting image data of the set of the first input terminals or image data of the set of the second input terminals and transmitting the selected image data to the set of the first output terminals;
a second switch coupled to the sets of the first and the second input terminals, for selecting a clock signal of the set of the first input terminal or a clock signal of the set of the second input terminals;
a gain unit coupled to the second switch, for gaining the clock signal selected by the second switch;
a third switch coupled to the second switch and the gain unit, for selecting the clock signal supplied by the second switch or the gain unit and transmitting the selected clock signal to the set of the first output terminals; and
a data latch coupled to the first switch and the third switch, for latching the image data outputted by the first switch based on the clock signal outputted by the third switch,
wherein the driving module is coupled to the data latch, so as to convert the image data outputted by the data latch to the driving signal.

4. The source driver as claimed in claim 1, wherein the interface module comprises:
a second switch coupled to the sets of the first and the second input terminals, for selecting a clock signal of the set of the first input terminals or a clock signal of the set of the second input terminals;
a gain unit coupled to the second switch, for gaining the clock signal selected by the second switch; and
a third switch coupled to the second switch and the gain unit, for selecting the clock signal supplied by the second switch or the gain unit and transmitting the selected clock signal to the set of the first output terminals,
wherein the driving module is coupled to the third switch, so as to receive the clock signal outputted by the third switch.

5. The source driver as claimed in claim 1, wherein the interface module comprises:
a fourth switch coupled to the sets of the first and the second input terminals, for selecting a control signal of the set of the first input terminals or a control signal of the set of the second input terminals and transmitting the selected control signal to the set of the first output terminals,
wherein the driving module is coupled to the fourth switch, so as to generate the driving signal based on the control signal outputted by the fourth switch.

6. The source driver as claimed in claim 1, wherein the interface module comprises:
a fifth switch coupled to the sets of the first and the second input terminals, for selecting a power supply provided by the set of the first input terminals or a power supply provided by the set of the second input terminals and transmitting the selected power supply to the set of the first output terminals,
wherein the driving module is coupled to the fifth switch, so as to receive the power supply outputted by the fifth switch.

7. The source driver as claimed in claim 1, further comprising:
a select control terminal coupled to the interface module as an input interface of the pre-setting,
wherein the interface module determines to electrically connect the set of the first input terminals to the set of the first output terminals in case that the pre-setting is logic 1, and the interface module determines to electrically connect the set of the second input terminals to the set of the first output terminals in case that the pre-setting is logic 0.

8. The source driver as claimed in claim 1, wherein the driving module comprises:
a shift register for providing a latch timing;
a data-latch unit coupled to the shift register, for latching image data outputted by the interface module based on the latch timing; and
a digital-to-analog conversion unit coupled to the data-latch unit, for converting the image data latched by the data-latch unit to the driving signal.

9. The source driver as claimed in claim 1, wherein the source driver is disposed on a substrate of the display panel.

10. The source driver as claimed in claim 9, wherein the substrate of the display panel is a glass substrate.

11. The source driver as claimed in claim 1, wherein the source driver is packaged through a chip on glass (COG) technique.

12. The source driver as claimed in claim 1, wherein the source driver and the previous-stage/following stage source driver thereof are connected to one another through indium tin oxide (ITO).

13. A panel display apparatus, comprising:
a display panel, a surface of the display panel having a layout including a plurality of source driver pads and a plurality of connector pads, wherein each of the source driver pads is electrically connected to one of the connector pads, and the source driver pads are electrically connected to one another in series;
at least a connector, wherein a first end thereof is disposed in one of the connector pads;
a timing controller electrically connected to a second end of the connector, wherein the timing controller is coupled to the display panel through the connector; and
a plurality of source drivers, wherein each of the source drivers is disposed in one of the source driver pads, and each of the source drivers respectively comprises:
a set of first input terminals coupled to a previous-stage source driver through the source driver pads located at a position where the set of the first input terminals is located;
a set of second input terminals coupled to the connector pads through the source driver pads located at a position where the set of the second input terminals is located;
a set of first output terminals coupled to a following-stage source driver through the source driver pads located at a position where the set of the first output terminals is located;
a set of second output terminals coupled to a pixel array of the display panel through the source driver pads located at a position where the set of the second output terminals is located;
an interface module coupled to the sets of the first and the second input terminals, for selecting the set of the first input terminals or the set of the second input terminals based on a pre-setting and electrically connecting the selected set of the input terminals to the set of the first output terminals; and
a driving module coupled to the interface module, for generating at least a driving signal based on a signal of the selected set of the input terminals, wherein the driving signal is outputted to the pixel array of the display panel through the set of the second output terminals.

14. The panel display apparatus as claimed in claim 13, wherein the connectors are fewer than the connector pads.

15. The panel display apparatus as claimed in claim 13, wherein the interface module comprises:
a first switch coupled to the sets of the first and the second input terminals, for selecting image data of the set of the first input terminals or image data of the set of the second input terminals and transmitting the selected image data to the set of the first output terminals,
wherein the driving module is coupled to the first switch, so as to convert the image data outputted by the first switch to the driving signal.

16. The panel display apparatus as claimed in claim 13, wherein the interface module comprises:
a first switch coupled to the sets of the first and the second input terminals, for selecting image data of the set of the first input terminals or image data of the set of the second input terminals and transmitting the selected image data to the set of the first output terminals;
a second switch coupled to the sets of the first and the second input terminals, for selecting a clock signal of the set of the first input terminals or a clock signal of the set of the second input terminals;
a gain unit coupled to the second switch, for gaining the clock signal selected by the second switch;
a third switch coupled to the second switch and the gain unit, for selecting the clock signal supplied by the second switch or the gain unit and transmitting the selected clock signal to the set of the first output terminals; and
a data latch coupled to the first switch and the third switch, for latching the image data outputted by the first switch based on the clock signal outputted by the third switch,
wherein the driving module is coupled to the data latch, so as to convert the image data outputted by the data latch to the driving signal.

17. The panel display apparatus as claimed in claim 13, wherein the interface module comprises:
a second switch coupled to the sets of the first and the second input terminals, for selecting a clock signal of the set of the first input terminals or a clock signal of the set of the second input terminals;
a gain unit coupled to the second switch, for gaining the clock signal selected by the second switch; and
a third switch coupled to the second switch and the gain unit, for selecting the clock signal supplied by the second switch or the gain unit and transmitting the selected clock signal to the set of the first output terminals,
wherein the driving module is coupled to the third switch, so as to receive the clock signal outputted by the third switch.

18. The panel display apparatus as claimed in claim 13, wherein the interface module comprises:
a fourth switch coupled to the sets of the first and the second input terminals, for selecting a control signal of the set of the first input terminals or a control signal of the set of the second input terminals and transmitting the selected control signal to the set of the first output terminals,
wherein the driving module is coupled to the fourth switch, so as to generate the driving signal based on the control signal outputted by the fourth switch.

19. The panel display apparatus as claimed in claim 13, wherein the interface module comprises:
a fifth switch coupled to the sets of the first and the second input terminals, for selecting a power supply provided by the set of the first input terminals or a power supply provided by the set of the second input terminals and transmitting the selected power supply to the set of the first output terminals,
wherein the driving module is coupled to the fifth switch, so as to receive the power supply outputted by the fifth switch.

20. The panel display apparatus as claimed in claim 13, wherein each of the source drivers further comprises:
a select control terminal coupled to the interface module as an input interface of the pre-setting,
wherein the interface module determines to electrically connect the set of the first input terminals to the set of the first output terminals in case that the pre-setting is logic 1, and the interface module determines to electrically connect the set of the second input terminals to the set of the first output terminals in case that the pre-setting is logic 0.

21. The panel display apparatus as claimed in claim 13, wherein the driving module comprises:
a shift register for providing a latch timing;
a data-latch unit coupled to the shift register, for latching image data outputted by the interface module based on the latch timing; and
a digital-to-analog conversion unit coupled to the data-latch unit, for converting the image data latched by the data-latch unit to the driving signal.

22. The panel display apparatus as claimed in claim 13, wherein the substrate of the display panel is a glass substrate.

23. The panel display apparatus as claimed in claim 13, wherein the source driver is packaged on the display panel through a COG technique.

24. The panel display apparatus as claimed in claim 13, wherein the source driver pads are connected to one another through ITO, and the source driver pads are connected to the connector pads through ITO.
